(19) United States
(12) Patent Application Publication
(10) Pub. No.: US 2002/0113540 A1
(43) Pub. Date: Aug. 22, 2002

(54) Electric shielding and anti-glaring multi-layer coating for cathode ray tube and the method for making the same

(76) Inventors: Yuan-Hsiang Yu, Taipei (TW); Li-Sha Yu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/785,297

(22) Filed: Feb. 20, 2001

(51) Int. Cl. B05D 3/12

(52) U.S. Cl. 313/479; 313/480; 427/366; 428/209

(57) ABSTRACT

The present invention provides an electric shielding and anti-glaring multi-layer coating for cathode ray tube, and the method for making the same. A plurality of sputtering layers are formed on the outer surface of the glass panel of the CRT. An anti-glaring layer is formed on the outer surface of the sputtering layers by spraying. The plurality of sputtering layers contains conductive material such as ITO and having a protective layer to protect the conductive layer from acid corrosion. The multi-layer coating also has anti-reflection property in wide spectral range, and also has good hardness and resistance to fingerprint.

### FIELD OF THE INVENTION

The present invention relates to an electric shielding and anti-glaring multi-layer coating for cathode ray tube, especially to an electric shielding and anti-glaring multi-layer coating for cathode ray tube, which has good hardness and anti-smudge, and the method for making the same.

### BACKGROUND OF THE INVENTION

The conventional cathode ray tube (CRT) generally has one or a plurality of coating layers formed on the glass panel thereof by chemical coating process such as spin coating or spraying. To provide state-of-art cathode ray tube, the optical properties and electromagnetic properties on the surface of the cathode ray tube are important issues. However, the optical and electromagnetic quality of the cathode ray tube is hard to satisfy the quality requirement in the future if the surface coatings are made by spinning or spraying.

Moreover, the surface coatings made by conventional process further have following drawbacks. The sheet resistance is more than 10³Ω□ such that the electric shielding effect is not satisfactory. The light transmission rate is not easy to be adjustable and the reflection bandwidth is not sufficient.

To overcome above problems, PET films are attached on the glass surface as suggested by the TOYO Company to improve optical and electrical properties. However, the hardness of the PET film is not good (pencil hardness 3-4H) and damage becomes serious problem to the PET film.

Moreover, the surface coatings made by sputtering only have the problem of poor resistance to dirt and fingerprint. Moreover, the processing time is long and the cost is high to prohibit mass production.

### SUMMARY OF THE INVENTION

It is the object of the present invention to provide an electric shielding and anti-glaring multi-layer coating for cathode ray tube, which has good hardness and anti-smudge, and the method for making the same.

In one aspect of the present invention, the multi-layer coating comprises layers formed by sputtering; the sputtering layers have compact structure and smooth surface for enhancing the spraying of the anti-glaring layer.

In another aspect of the present invention, the multi-layer coating is formed by sputtering and spraying process, separately. Therefore, the multi-layer coating has high hardness, resistance to fingerprint. The multi-layer coating has low sheet resistance (smaller than 100Ω□) and thus has excellent electric shielding effect and satisfies the security requirement for reducing alternating electric field (AEF). Moreover, the multi-layer coating has a protective layer to facilitate the formation of an anti-glaring layer. The multi-layer coating has anti-glaring effect and anti-reflection effect in wide spectral range.

In another aspect of the present invention, the multi-layer coating can be used to adjust the light transmission rate of the glass panel.

In another aspect of the present invention, the present invention combines the process of sputtering and spraying to simplify process and enhance yield.

The various objects and advantages of the present invention will be more readily understood from the following detailed description when read in conjunction with the appended drawing, in which:

### BRIEF DESCRIPTION OF DRAWING

FIG. 1 shows the preferred embodiment of the present invention;

FIG. 2 shows the sectional view of the multi-layer coating of the present invention;

FIG. 3 shows the flowchart of steps for manufacturing the electric shielding and anti-glaring multi-layer coating of the present invention; and

FIG. 4 shows the reflectance curve of the glass panel applied with the electric shielding and anti-glaring multi-layer coating of the present invention.

### DETAILED DESCRIPTION OF THE INVENTION

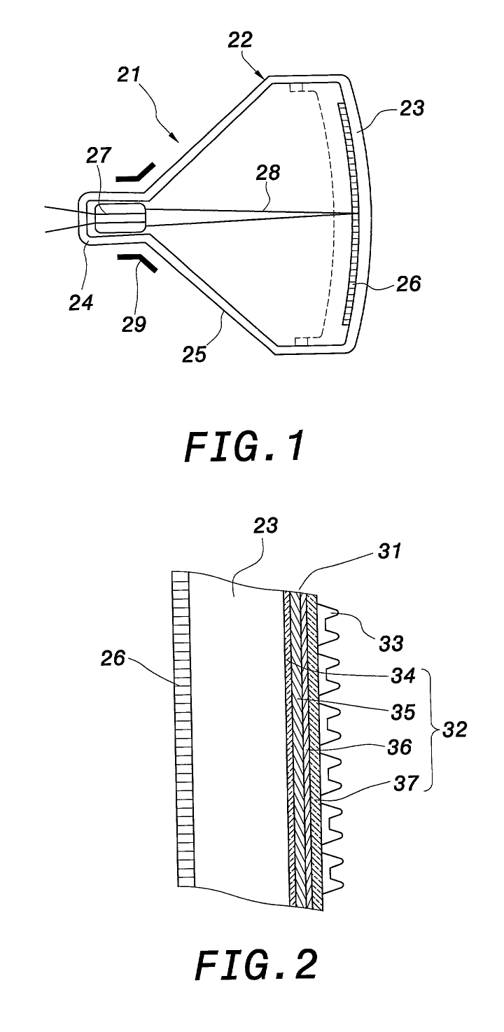

FIG. 1 shows the preferred embodiment of the present invention. The electric shielding and anti-glaring multi-layer coating for CRT according to the present invention can be applied to a CRT 21. The CRT 21 mainly comprises a glass hood 22 which include a glass panel 23, a neck 24 and a funnel 25. The glass panel 23 has a fluorescent layer 26 on the inner surface thereof and composed of a plurality of fluorescent dots. When the thermionic electrons are landing on the fluorescent dots on the inner surface of the glass panel 23. The fluorescent dots emit light of various colors to form color image on the glass panel 23. The neck 24 houses a plurality of electron guns 27 in linear arrangement, and the electron guns 27 generate a plurality of electron beams 28 focused on the fluorescent layer 26 by the defection yoke 29, which deflect the electron beams 28 in vertical and horizontal directions. However, the above-mentioned components are well-known arts and will not be described in detail.

With reference now to FIG. 2, the glass panel 23 of the CRT 21 has an electric shielding and anti-glaring multi-layer coating 31 on the outer surface thereof. The electric shielding and anti-glaring multi-layer coating 31 comprises a sputtering multi-layers 32 and an anti-glaring layer 33. The sputtering multi-layers 32 comprises an adhesion layer 34, a light absorbing layer 35, a conductive layer 36 and a protective layer 37, wherein above layers are formed by sputtering. The major component of the adhesion layer 34 is silicon dioxide with thickness about 10-20 nm (10⁻⁹ m) to enhance the adhesion of other sputtering layers. The major component of the light absorbing layer 35 is Cr, Zn or their metal oxide to control the transmittance of light and has thickness about 10-20 nm (10⁻⁹ m). The major component of the conductive layer 36 is indium-tin oxide (ITO) and the thickness thereof is about 20-40 nm (10⁻⁹ m). The conductive layer 36 is formed by sputtering to have compact structure such that the conductive layer 36 has small sheet resistance 100Ω□. The conductive layer 36 is connected to a protective steel band (not shown) to ground the conductive layer 36. Therefore, the glass panel 23 of the CRT 21 has electric shielding property. The major component of the protective layer 37 is silicon dioxide to protect the conductive layer 36. More particularly, the protective layer 37 protects the conductive layer 36 from acid corrosion during the process of the anti-glaring coating 31. The thickness of the protective layer 37 is about 20-30 nm (10⁻⁹ m). Therefore, the overall thickness of the sputtering multi-layers 32 can be restricted to 80-110 nm (10⁻⁹ m).

In the present invention, after the sputtering multi-layers 32 is formed, the glass panel 23 is pre-heated to 30-100° C. and then an anti-glaring material is sprayed to the protective layer 37. The sprayed anti-glaring material is then baked at the temperature 150-180° C. for 20-40 minutes. Afterward, the baked material is cooled to room temperature to form an anti-glaring layer 33 with surface density 0.001-0.01 mg/cm².

The averaged molecular weight of the anti-glaring material is about 1500-4000 g/mole. The anti-glaring material is water soluble material and comprises 5-15 wt % silicon oxide (with formula: Si(OEt)₄; Et: ethyl), 0.05-0.1 wt % nitric acid, 30-40 wt % ethyl alcohol, 5-10 wt % isopropyl alcohol, 5-10 wt % methyl alcohol, 3-8 wt % 2-methyl ethyl ketone and 0.1-0.5 wt % surfactant POP (Polyalklene Oxide-modified Polydimethylsiloxanes).

The electric shielding and anti-glaring multi-layer coating of the present invention is applied to the outer surface of the glass panel 23 of the CRT 21. The sheet resistance of the glass panel 23 is tested to be 80-100Ω□ and the pencil hardness thereof is large than 9H, the gloss value is about 40-70%, and having resistance to fingerprint.

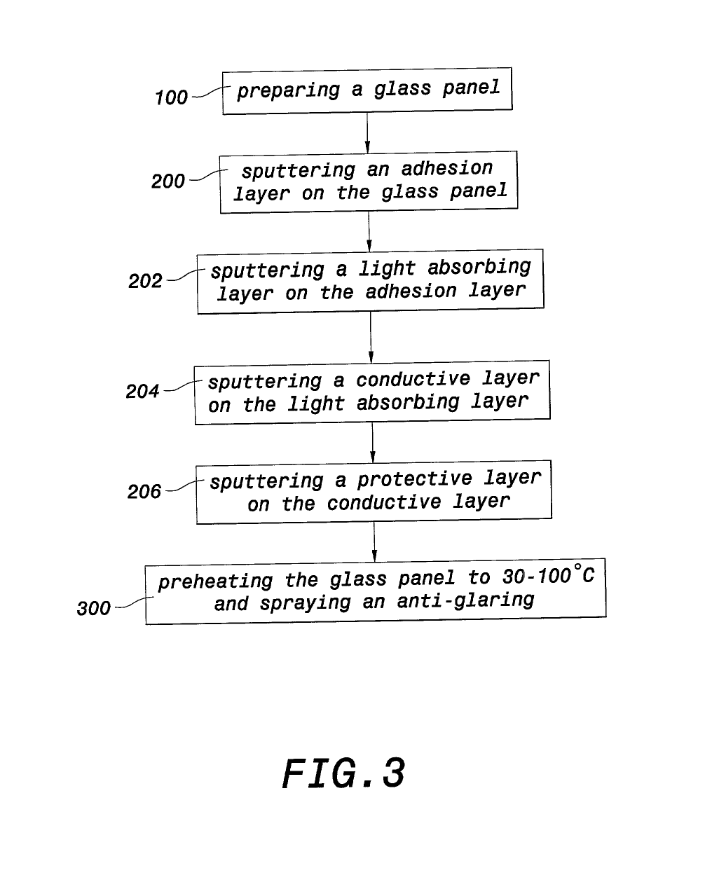

FIG. 3 shows the flowchart of steps for manufacturing the electric shielding and anti-glaring multi-layer coating of the present invention, which is applied to the outer surface of the glass panel 23 of the CRT 21. The surface. The manufacturing method has following steps.

Step 100: preparing a glass panel;

Step 200: sputtering an adhesion layer on the glass panel;

Step 202: sputtering a light absorbing layer on the adhesion layer;

Step 204: sputtering a conductive layer on the light absorbing layer;

Step 206: sputtering a protective layer on the conductive layer; and

Step 300: spraying an anti-glaring layer on the protective layer;

wherein before the step 300, the glass panel is pre-heated to 30-100° C. and then an anti-glaring material is sprayed to the protective layer.

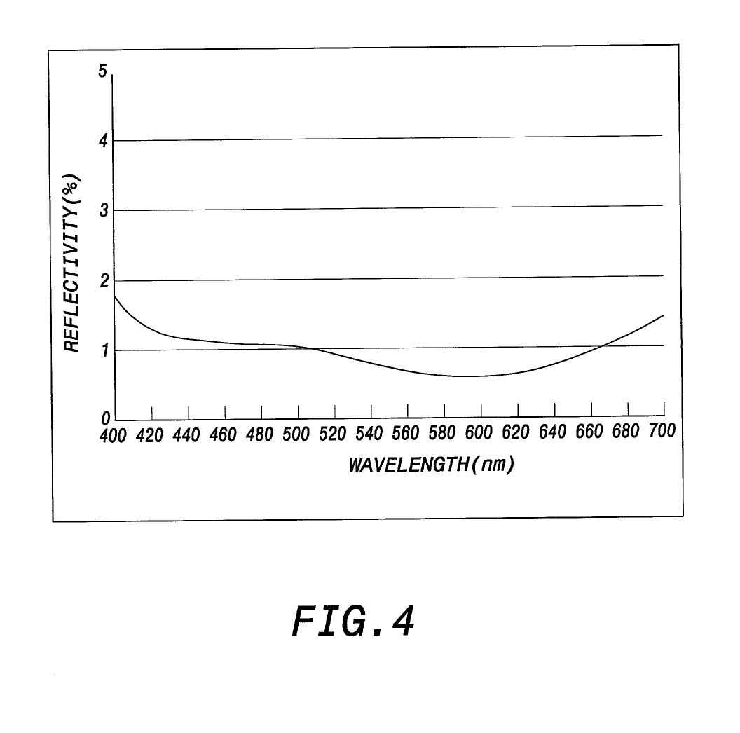

FIG. 4 shows the reflectance curve of the glass panel applied with the electric shielding and anti-glaring multi-layer coating of the present invention. As shown in this figure, the electric shielding and anti-glaring multi-layer coating has low-reflectivity between the spectral range 400-700 nm(10⁻⁹ m). Therefore, the multi-layer coating of the present invention has low-reflectivity in wide bandwidth range.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. An electric shielding and anti-glaring multi-layer coating for cathode ray tube; the cathode ray tube having a glass panel; the electric shielding and anti-glaring multi-layer coating comprising
a plurality of sputtering layers formed on the outer surface of the glass panel by sputtering and functioned as electric shielding coating;
an anti-glaring layer formed on the outer surface of the sputtering layers by spraying.

2. The electric shielding and anti-glaring multi-layer coating for cathode ray tube as in claim 1, wherein the electric shielding coating is formed by sputtering and comprises:
an adhesion layer sputtered on outer surface of the glass panel;
a light absorbing layer sputtered on outer surface of the adhesion layer;
a conductive layer sputtered on outer surface of the light absorbing layer; and
a protective layer sputtered on outer surface of the conductive layer.

3. The electric shielding and anti-glaring multi-layer coating for cathode ray tube as in claim 2, wherein the major component of the adhesion layer is silicon dioxide with thickness about 10-20 nm (10⁻⁹ m).

4. The electric shielding and anti-glaring multi-layer coating for cathode ray tube as in claim 2, wherein the major component of the light absorbing layer is Cr, Zn or their metal oxide and has thickness about 10-20 nm (10⁻⁹ m).

5. The electric shielding and anti-glaring multi-layer coating for cathode ray tube as in claim 2, wherein the major component of the conductive layer is indium-tin oxide (ITO) and the thickness thereof is about 20-40 nm (10⁻⁹ m).

6. The electric shielding and anti-glaring multi-layer coating for cathode ray tube as in claim 2, wherein the major component of the protective layer is silicon dioxide and the thickness of the protective layer is about 20-30 nm (10⁻⁹ m).

7. The electric shielding and anti-glaring multi-layer coating for cathode ray tube as in claim 2, wherein the conductive layer is grounded through a conductor.

8. The electric shielding and anti-glaring multi-layer coating for cathode ray tube as in claim 2, wherein the anti-glaring layer is formed by spraying an anti-glaring material, the anti-glaring material is a water soluble material containing
5-15 wt % silicon oxide;
0.05-0.1 wt % acid;
5-50 wt % alcohol;
3-8 wt % 2-methyl ethyl ketone; and
0.1-0.5 wt % surfactant.

9. The electric shielding and anti-glaring multi-layer coating for cathode ray tube as in claim 8, wherein the silicon oxide has formula: Si(OEt)₄; and Et is ethyl; the water dissoluble anti-glaring material has averaged molecular weight about 1500-4000 g/mole; the acid including sulfuric acid, nitric acid and hydrochloric acid; the alcohol including isopropyl alcohol, methyl alcohol and ethyl alcohol; and the surfactant is POP (Polyalklene Oxide-modified Polydimethylsiloxanes).

10. The electric shielding and anti-glaring multi-layer coating for cathode ray tube as in claim 1, wherein the anti-glaring layer has surface density about 0.001-0.01 mg/cm².

11. A manufacturing method for electric shielding and anti-glaring multi-layer coating for cathode ray tube, comprising following steps:
preparing a glass panel;
sputtering an adhesion layer on the glass panel;
sputtering a light absorbing layer on the adhesion layer;
sputtering a conductive layer on the light absorbing layer;
sputtering a protective layer on the conductive layer; and
spraying an anti-glaring material on the protective layer to form an anti-glaring layer.

12. The manufacturing method for electric shielding and anti-glaring multi-layer coating as in claim 11, wherein the major component of the adhesion layer is silicon dioxide with thickness about 10-20 nm (10⁻⁹ m).

13. The manufacturing method for electric shielding and anti-glaring multi-layer coating as in claim 11, wherein the major component of the light absorbing layer is Cr, Zn or their metal oxide and has thickness about 10-20 nm (10⁻⁹ m).

14. The manufacturing method for electric shielding and anti-glaring multi-layer coating as in claim 11, wherein the major component of the conductive layer is indium-tin oxide (ITO) and the thickness thereof is about 20-40 nm (10⁻⁹ m).

15. The manufacturing method for electric shielding and anti-glaring multi-layer coating as in claim 11, wherein the major component of the protective layer is silicon dioxide and the thickness of the protective layer is about 20-30 nm (10⁻⁹ m).

16. The manufacturing method for electric shielding and anti-glaring multi-layer coating as in claim 11, wherein the conductive layer is grounded through a conductor.

17. The manufacturing method for electric shielding and anti-glaring multi-layer coating as in claim 11, wherein the anti-glaring layer is formed by spraying an anti-glaring material, the anti-glaring material is a water soluble material containing
5-15 wt % silicon oxide;
0.05-0.1 wt % acid;
5-50 wt % alcohol;
3-8 wt % 2-methyl ethyl ketone; and
0.1-0.5 wt % surfactant.

18. The manufacturing method for electric shielding and anti-glaring multi-layer coating as in claim 17, wherein the silicon oxide has formula: Si(OEt)₄; and Et is ethyl; the water dissoluble anti-glaring material has averaged molecular weight about 1500-4000 g/mole; the acid including sulfuric acid, nitric acid and hydrochloric acid; the alcohol including isopropyl alcohol, methyl alcohol and ethyl alcohol; and the surfactant is POP (Polyalklene Oxide-modified Polydimethylsiloxanes).

19. The manufacturing method for electric shielding and anti-glaring multi-layer coating as in claim 11, wherein the anti-glaring layer has surface density about 000.1-0.01 mg/cm².
